(19) United States
(12) Patent Application Publication
(10) Pub. No.: US 2026/0106871 A1
(43) Pub. Date: Apr. 16, 2026

(54) File operation policy enforcement

(71) Applicant: SAILPOINT TECHNOLOGIES, INC, Wilmington, DE (US)

(72) Inventors: Eldar Kleiner, Tel Aviv (IL); David Ben Zakai, Ramat Gan (IL); Timor Eizenman, Tel Aviv-Yafo (IL)

(21) Appl. No.: 18/915,395

(22) Filed: Oct. 15, 2024

(51) Int. Cl. H04L 9/40; G06F 16/13; G06F 21/62

(52) U.S. Cl. CPC H04L 63/10; G06F 16/13; G06F 21/6218

(57) ABSTRACT

A method for protecting a computer which includes a processor configured to access a set of files, the method including the processor detecting a first request to access a given file. in response to the first request, a notification of the first request is conveyed by the processor to a server prior to executing the first request. In response to receiving the notification, a second request to retrieve metadata from the given file is conveyed by the server to the computer. In response to receiving the second request, the requested metadata is retrieved from the given file by the processor. The retrieved metadata is conveyed by the computer to the server, and in response to receiving the conveyed metadata, a decision as to whether to authorize the first request is conveyed from the server to the computer. Finally, the processor responds to the first request in accordance with the decision.

### FIELD OF THE INVENTION

The present invention relates generally to computer security, and specifically to a security server configured to enforce file access policies for client computers.

### BACKGROUND OF THE INVENTION

File access policies are crucial for maintaining the security and integrity of data within an organization. These policies determine who can access specific files, what actions they can perform, and under what conditions access is granted. By clearly defining these parameters, organizations can prevent unauthorized access, mitigate the risk of data breaches, and ensure compliance with regulatory requirements. Additionally, file access policies help in maintaining data integrity by ensuring that only authorized personnel can modify or delete sensitive information, thus protecting the organization from potential data loss or corruption.

Furthermore, file access policies support efficient data management by providing a structured approach to access control. This enhances operational efficiency as employees can quickly access requested information without compromising security. It also facilitates auditing and monitoring of file access activities, which is essential for identifying and responding to suspicious behavior promptly. Overall, robust file access policies are a foundational element of a comprehensive cybersecurity strategy, safeguarding both the organization's data assets and its reputation.

The description above is presented as a general overview of related art in this field and should not be construed as an admission that any of the information it contains constitutes prior art against the present patent application.

### SUMMARY OF THE INVENTION

There is provided, in accordance with an embodiment of the present invention, a method for protecting a client computer, which includes a processor configured to access a set of files, the method including detecting, by the processor, a first request to access a given file in the set, in response to the first request, conveying, by the processor prior to executing the first request, a notification of the first request over a network to a security server, in response to receiving the notification, conveying, by the security server to the client computer over the network, a second request to retrieve metadata from the given file, retrieving, by the processor in response to receiving the second request, the requested metadata from the given file, conveying, by the client computer, the retrieved metadata to the security server over the network, conveying, from the security server to the client computer over the network, in response to receiving the conveyed metadata, a decision as to whether to authorize the first request and responding by the processor to the first request in accordance with the decision.

In one embodiment, the first request includes a file identifier (ID) for the file, wherein the access includes a specific operation on the file, and the method further includes generating, prior to conveying the decision, the decision based on the file ID and the specific operation.

In a first information embodiment, the request includes information about the computer, and generating the decision includes generating the decision based on file ID, the specific operation, and the information about the computer.

In a second information embodiment, the information about the computer includes information about a user of the computer.

In another embodiment, the metadata includes labels for the given file.

In an additional embodiment, the method further includes opening a communication channel between the client computer and the security server in response to detecting the first request, wherein the second request, the retrieved metadata and the decision are conveyed over the communication channel.

In a first protocol embodiment, the communication channel includes a synchronous communication protocol.

In a second protocol embodiment, the synchronous communication protocol includes WebSocket.

In a third protocol embodiment, opening the communication channel includes the client computer opening the communication channel.

In a fourth protocol embodiment, opening the communication channel includes the client computer conveying, over the network, an additional request to open the communication channel, and the security server opening the communication channel in response to receiving the additional request.

In a fifth protocol embodiment, the processor includes a client processor executing an endpoint agent, wherein the server includes a server processor executing a file information library, wherein conveying the second request includes the server processor conveying the second request to the file information library, and the file information library forwarding the second request to the endpoint agent over the communication channel, wherein conveying the retrieved metadata includes the endpoint agent conveying the retrieved metadata to the file information library over the communication channel, and wherein conveying the decision includes the server processor conveying the decision to the endpoint agent over the communication channel.

In some embodiments, the endpoint agent includes an extension for a web browser.

In a further embodiment, the first request includes a request to upload the given file to a remote server.

In a supplemental embodiment, the first request includes a request to download the given file from a remote server.

In one embodiment, the first request includes a request to delete the given file.

In another embodiment, the first request includes a request to read data from the given file.

In an additional embodiment, the first request includes a request to write data to the given file.

There is also provided, in accordance with an embodiment of the present invention, a security server, including a network interface controller coupled to a network, and a processor configured to receive, via the network, a notification indicating a client computer generating a first request to access a file, in response to receiving the notification, to convey, to the client computer over the network, a second request to retrieve metadata from the given file, to receive the requested metadata from the client computer in response to the second request, and in response to receiving the conveyed metadata, to convey, to the client computer over the network, a decision as to whether to authorize the first request, so as to enable the client computer to respond to the first request in accordance with the decision.

There is additionally provided, in accordance with an embodiment of the present invention, computer software product for protecting a client computer configured to access a set of files, the computer software product including a non-transitory computer-readable medium, in which program instructions are stored, which instructions, when read by the client computer and a security server, cause the client computer to detect a first request to access a given file in the set, in response to the first request, the client computer to convey, prior to executing the first request, a notification of the first request over a network to the security server, in response to receiving the notification, the security server to convey to the client computer over the network, a second request to retrieve metadata from the given file, the client computer to retrieve, in response to receiving the second request, the requested metadata from the given file, the client computer to convey, the retrieved metadata to the security server over the network, in response to receiving the conveyed metadata, the security server to convey, to the client computer over the network, a decision as to whether to authorize the first request, and the client computer to respond by to the first request in accordance with the decision.

### BRIEF DESCRIPTION OF THE DRAWINGS

The disclosure is herein described, by way of example only, with reference to the accompanying drawings, wherein:

FIG. 1 is a block diagram that schematically shows a computing facility comprising a security server that is configured to communicate with a client computer so as t to authorize a request to access to a file, in accordance with an embodiment of the present invention;

FIG. 2 is a block diagram that shows data components of the file, in accordance with an embodiment of the present invention; and

FIG. 3 is a block diagram that shows hardware and software components of the client computer, in accordance with an embodiment of the present invention; and

FIG. 4 is a block diagram that shows hardware and software components of the security server, in accordance with an embodiment of the present invention; and

FIG. 5 is a flow diagram that schematically illustrates a method of using policies for analyzing file access requests, in accordance with an embodiment of the present invention.

### DETAILED DESCRIPTION OF EMBODIMENTS

Embodiments of the present invention provide methods and systems for protecting a client computer, the client computer comprising a processor configured to access a set of files. As described hereinbelow, a first request to access a given file in the set is detected by the processor, and in response to the first request, a notification of the first request is conveyed, over a network, by the processor to a security server prior to executing the first request. In response to receiving the notification, a second request to retrieve metadata from the given file is conveyed by the security server to the client computer over the network.

In response to receiving the second request, the requested metadata from the given file is retrieved by the processor, and the retrieved metadata is conveyed by the client computer to the security server over the network. In response to receiving the conveyed metadata, a decision as to whether to authorize the first request is conveyed, from the security server to the client computer over the network, and finally, the processor responds to the first request in accordance with the decision.

Having the security server convey the second request (i.e., for the metadata) to the client computer obviates any need to transfer the given file to the security server, thereby (a) saving time and system resources, and (b) enabling analysis of the file in situations where security considerations preclude loading the given file to the security server. In some embodiments, an API for a file information library executing on the security server can be modified so as to enable the file information library to communicate with the client computer via a synchronous communication channel, thereby enabling the file information library to seamlessly retrieve the requested metadata from the client computer.

### System Description

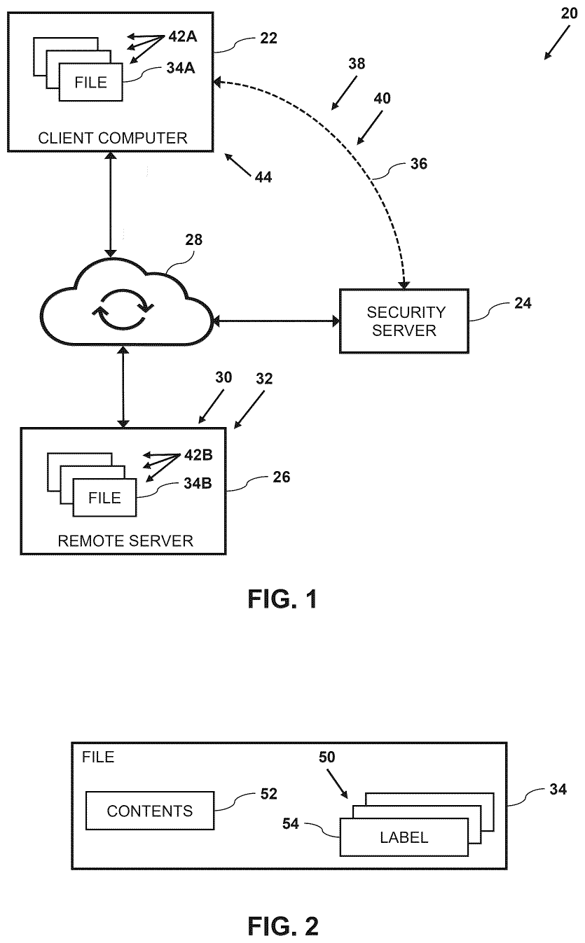

FIG. 1 is a block diagram that shows an example of a computing facility 20, in accordance with an embodiment of the present invention. In the configuration shown in FIG. 1, computer facility 20 comprises a client computer 22 that can communicate with a security server 24 and a remote server 26 over a data network 28 such as the Internet. In embodiments herein, data network 28 may also be referred to as Internet 28, and remote server 26 is addressable (i.e., is associated with) on the Internet via a domain 30 and/or an Internet Protocol (IP) address 32.

Client computer 22 and remote server 26 are configured to store a set of files 34 that can be accessed by the client computer. Files 34 have respective file identifiers (IDs) 42. Examples of file IDs 42 include file names and computed hash values for the files. In embodiments herein, files 34 can be differentiated by appending a letter to the identifying numeral, so that the file comprise local files 34A stored on client computer 22 and having respective file IDs 42A, and remote files 34B stored on remote server 26 and having respective file IDs 42B.

As described hereinbelow, upon client computer 22 requesting access to a given file 34, the client computer can convey, to security server 24 via a communication channel 36 on Internet 28, a notification 38 of the request. Upon receiving notification 38, security server 24 can analyze the received request using embodiments described herein and convey, to client computer 22 via communication channel 36, a decision as to whether to authorize the request (i.e., to the given file).

In one embodiment, communication channel 36 may comprise Hypertext Protocol (HTTP) requests. In another embodiment, communication channel 36 may comprise a synchronous (i.e., full-duplex) communication channel using a protocol such as WebSocket (as described in the RFC 6455 international standard).

Examples of access to a given file 34 include, but are not limited to, reading data from a given file 34, modifying a given file 34, deleting a given file 34, copying a given file 34A to remote server 26, and copying a given file 34B to client computer 22.

In some embodiments, client computer 22 may have an associated computer ID 44 that can indicate information about the client computer, such as a physical location of the client computer (e.g., in a specific department of an organization). In some embodiments, information about the client computer may comprise information about a current user of the client computer (e.g., the user's privileges, or a department where the user works in an organization).

FIG. 2 is a block diagram that shows data components of a given file 34, in accordance with an embodiment of the present invention. In the configuration shown in FIG. 2, the given file comprises metadata 50 and contents 52. Example of contents 52 include program instructions (i.e., executable code) and data used by a software application (not shown).

In some embodiments, metadata 50 may comprise labels 54 that indicate features for the given file. In NEW TECHNOLOGY FILE SYSTEM™ (NTFS™) environments (produced by MICROSOFT CORPORATION, One Microsoft Way, Redmond, WA, USA), labels 54 for a given file 34 can be a text string describing attributes for the given file. Examples information stored in NTFS™ labels 54 for files 34 include, but are not limited to, file name, file size, file permissions (i.e., an access control list that specifies permissions for users and groups), file creation timestamp, last access timestamp, last write timestamp, owner information (i.e., a user or a group), and file attributes (also known as stream information) such as read-only, hidden, system, archive, compressed, encrypted and a confidentiality flag (i.e., indicating if the given file comprises confidential information).

In some embodiments, client computer 22 may receive, from a user (not shown) of the client computer 22 custom labels for a given file 34A, and the client computer can store the received custom labels to labels 54 for the given file.

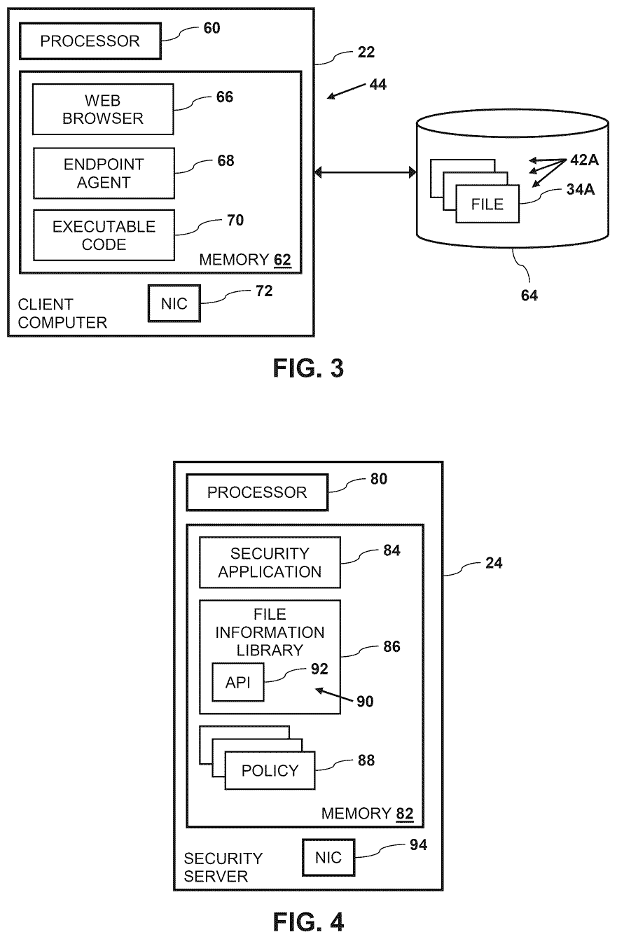

FIG. 3 is a block diagram that shows hardware and software components of client computer 22, in accordance with an embodiment of the present invention. In the configuration shown in FIG. 3, client computer 22 comprises a client processor 60 a client memory 62, a storage device 64 that can store files 34A, and a client network interface card (NIC) 72 that couples the client computer to data network 28. In embodiments described hereinbelow, processor 60 performs all communication between client computer 22 and security server 24 (i.e., over Internet 28) via NIC 72.

While the configuration in FIG. 3 shows client computer 22 comprising storage device 64, and local files 34A stored on the storage device, other configurations for storing local files 34A are considered to be within the spirit and scope of the present invention. For example, storage device 64 may comprise a network attached storage (NAS) device that communicates with client computer 22 via a local area network (not shown).

Memory 62 comprises a web browser 66 (e.g., CHROME™ produced by ALPHABET INC., 1600 Amphitheatre Parkway, Mountain View, CA 94043, USA) that can execute on processor 60. Memory 62 may also comprise an endpoint agent 68 (i.e., a security application) that is configured, when executing on processor 60, to perform client-side embodiments described herein. In some embodiments, endpoint agent 68 may be implemented as a browser extension (also known as a browser plugin or simply an extension) for web browser 66.

Memory 62 also comprises executable code 70 (e.g., program instructions that can execute on processor 60). In some embodiments, executable code 70 may comprise browser executable code (e.g., HTML) that can execute in web browser 66. Upon processor 60 (e.g., via web browser 66) executing executable code 70, endpoint agent 68 can detect (i.e., in the executable code) a request to access a given file 34, and in response to detecting the request, the endpoint agent can convey notification 38 to security server 24.

FIG. 4 is a block diagram that shows hardware and software components of security server 24, in accordance with an embodiment of the present invention. In the configuration shown in FIG. 4, security server 24 comprises a server processor 80 and a server memory 82 that comprises a security application 84, a file information library 86, a set of policies 88, and a server network interface card (NIC) 94 that couples the security server to data network 28. In embodiments described hereinbelow, processor 80 performs all communication between security server 24 and client computer 22 (i.e., over Internet 28) via NIC 94.

File information library 86 comprises a set of functions 90 that security application 84 (i.e., executing on processor 80) can call via a file analysis application programming interface (API) 92, the functions configured to extract metadata 50 (i.e., file information) from a given file 34. An example of file information library 86 is the MICROSOFT INFORMATION PROTECTION SOFTWARE DEVELOPMENT KIT™ (MIP SDK™) that can extract labels 54 from files 34 in NTFS™ environments.

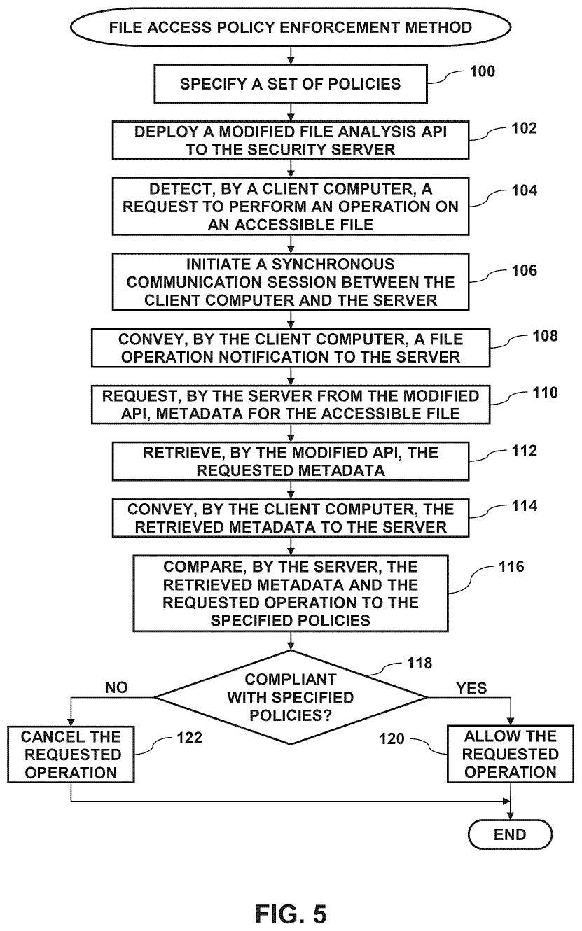

Security application 84 executes on processor 80, and is configured to perform the following steps:
Receive, from endpoint agent 68, notification 38 comprising an access request to access (i.e., perform a given operation on) a given file 34.
Call one or more functions 90 via API 92 so as to retrieve metadata 50 from the given file.
Compare the received request and the retrieved metadata to policies 88.
Based on the comparison, generate decision 40 to either allow or cancel the access request. Examples of access requests are described in the description referencing FIG. 5 hereinbelow.
Convey decision 40 to endpoint agent 68.

Typically, API 92 (i.e., for MIP SDK™) is configured to analyze locally stored files. However, this may not be practical in computing facility 20 for the following two reasons. First, loading a given file 34 (i.e., so the given file can be analyzed by security server 24) can be a resource and time intensive process. Second, if a given file comprises confidential information for an organization (i.e., where client computer 22 is deployed), the organization may have a security directive that prohibits transmission of the given file (or any file 34 comprising confidential information) to an offsite server such as security server 24.

In embodiments of the present invention, API 92 (also referred to herein as file analysis API 92) can be modified so as to communicate with endpoint agent 68 via communication channel 36, thereby enabling functions 90 to extract metadata 50 from files 34A and 34B. In these embodiments, upon API 92 receiving a given call (i.e., for a given function 90) comprising a metadata request to extract metadata 50 from a given file 34, the (modified) API forwards, via communication channel 36, the received metadata request to endpoint agent 68.

Upon receiving the metadata request, endpoint agent 68 extracts metadata 50 (e.g., labels 5) from the given file, the endpoint agent conveys, via communication channel 36, the extracted metadata to modified API 92. Upon receiving the extracted metadata, modified API conveys the received metadata in a response to the given call.

Policies 88 can be customized for different organizations (i.e., companies deploying endpoint agent 68 on their client computers 22). Policies can be based on labels 54, requested operations on files 34, domains 30 and IP addresses 32. For example, a given policy 88 may prohibit uploading any file 34 comprising confidential information (as indicated by a given label 54 to any domain 30 associated with a file hosting service (e.g., dropbox.com).

Processors 60 and 80 comprise general-purpose central processing units (CPU) or special-purpose embedded processors, which are programmed in software or firmware to carry out the functions described herein. This software may be downloaded to client computer 22 and security server 24 in electronic form, over a network, for example. Additionally or alternatively, the software may be stored on tangible, non-transitory computer-readable media, such as optical, magnetic, or electronic memory media. Further additionally or alternatively, at least some of the functions of processors 60 and 80 may be carried out by hard-wired or programmable digital logic circuits.

Examples of memory 62, memory 82, and storage device 64 include dynamic random-access memories, non-volatile random-access memories, hard disk drives and solid-state disk drives.

In some embodiments, tasks described herein performed by client computer 22, security server 24 and remote server 26 may be split among multiple physical and/or virtual computing devices such as physical and/or virtual servers. In other embodiments, these tasks may be performed by a managed cloud service.

### File Access Detection and Policy Enforcement

FIG. 5 is a flow diagram that schematically illustrates a method of using policies for analyzing a request to access a given file 34, in accordance with an embodiment of the present invention. In embodiments herein, the request to access the given file may comprise a request to upload the given file to server 26, a request to download the given file from server 26, a request to delete the given file, a request to read data from the given file and a request to write data to the given file.

In step 100, processor 80 specifies policies 88, and stores the policies to memory 62.

In step 102, processor 80 deploys modified API 92 to memory 62 in security server 24. The modifications to API 92 are described supra. Processor 60 also deploys endpoint agent 68 to client computer 22.

In step 104, endpoint agent 68 detects a request (i.e., generated by processor 60) to access (i.e., perform a specific operation on) a given file 34.

In one embodiment, the request to access the given file may comprise a request to upload the given file from client computer 22 to remote server 26. In some embodiments, as described in U.S. patent application Ser. No. 18/498,111, which is incorporated herein by reference, the request to upload the given file can be detected by hotpatching the ondrop handler in the HTMLElement interface so that upon being called, the ondrop handler conveys, to endpoint agent 68, a notification that processor 60 generated a request to upload (i.e., “drop”) the given file to remote server 26.

Alternatively, the EventTarget.prototype.addEventListener method can be hotpatched so as to generate the notification upon registering an ondrop event.

In step 106 communication channel 36 is initiated between client computer 22 and security server 24. As described supra, communication channel 36 may comprise a synchronous communication channel using a protocol such as WebSocket. In MICROSOFT WINDOWS™ environments, the following operating system API call can be used to open communication channel 36 using the WebSocket protocol:

$$const ws = new WebSocket ( < url > ) ;$$

In one embodiment, endpoint agent 68 (or any process executing on processor 60) can initiate communication channel 36. In another embodiment, endpoint agent 68 can convey, to security server 24, a request to initiate communication channel 36, and the processor 80 can initiate the communication channel in response to the request.

In step 108, endpoint agent 68 conveys, via communication channel 36, notification 38 to security server 24. Notification 38 may comprise information such as file ID 42 for the given file, the requested operation, and computer ID 44.

In step 110, upon receiving notification 38, security application 84 conveys, to modified API 92, a request for metadata 50 in the given file. In NTFS™ environments, the following API call can be used to request labels 54 (comprising stream information):

$$\_ws . Send ( String . Format ( “ \{ 0 \} ; R ; \{ 1 \} ; \{ 2 \} ” , fileId , position , count ) ) ;$$

In step 112, in response to receiving the request for the metadata modified API 92 (i.e., executing on processor 80) communicates, with endpoint agent 68 via communication channel 36 so as to retrieve the requested metadata from the given file. In some embodiments, upon receiving the requested metadata, modified API 92 can parse the received metadata so as to extract labels 54. In NTFS™ environments, the retrieved metadata may also comprise system file attributes referenced by $ATTRIBUTE_LIST. In NTFS™, $ATTRIBUTE_LIST is a special system file attribute that stores information about other attributes associated with a file or directory. NTFS™ uses attributes to store metadata and data about files, and each attribute serves a specific purpose.

In step 114, endpoint agent 68 conveys the retrieved metadata to security application 84 via communication channel 36.

In step 116, upon receiving the retrieved metadata, security application 84 compares (one or more of) the following information to policies 88:
Labels 54
The requested operation
Computer ID 44

In step 118, if the comparison performed in step 116 indicates that the received request complies with (all) policies 88, then in step 120, security application conveys, to endpoint agent 68 via communication channel 36, decision 40 instructing the endpoint agent to continue (i.e., allow) execution of executable code 70 comprising the requested operation, and the method ends.

Returning to step 118, if the comparison performed in step 116 indicates that the received request is not compliant with any policy 88, then in step 122, security application conveys, to endpoint agent 68 via communication channel 36, decision 40 instructing the endpoint agent to cancel (i.e., not allow) the execution of executable code 70 comprising the requested operation, and the method ends.

Upon endpoint agent 68 receiving decision 40, the endpoint agent can respond to the requested operation that the endpoint agent detected in step 104. If decision 40 allows the requested operation, then endpoint agent 68 allows processor 60 to perform the requested operation. However, if decision 40 does not allow the requested operation, then endpoint agent 68 prevents processor 60 from performing the requested operation.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for protecting a client computer, which includes a processor configured to access a set of files, the method comprising:
detecting, by the processor, a first request to access a given file in the set;
in response to the first request, conveying, by the processor prior to executing the first request, a notification of the first request over a network to a security server;
in response to receiving the notification, conveying, by the security server to the client computer over the network, a second request to retrieve metadata from the given file;
retrieving, by the processor in response to receiving the second request, the requested metadata from the given file;
conveying, by the client computer, the retrieved metadata to the security server over the network;
conveying, from the security server to the client computer over the network, in response to receiving the conveyed metadata, a decision as to whether to authorize the first request; and
responding by the processor to the first request in accordance with the decision.

2. The method according to claim 1, wherein the first request comprises a file identifier (ID) for the file, wherein the access comprises a specific operation on the file, and further comprising generating, prior to conveying the decision, the decision based on the file ID and the specific operation.

3. The method according to claim 2, wherein the request comprises information about the computer, and wherein generating the decision comprises generating the decision based on file ID, the specific operation, and the information about the computer.

4. The method according to claim 3, wherein the information about the computer comprises information about a user of the computer.

5. The method according to claim 1, wherein the metadata comprises labels for the given file.

6. The method according to claim 1, and further comprising opening a communication channel between the client computer and the security server in response to detecting the first request, wherein the second request, the retrieved metadata and the decision are conveyed over the communication channel.

7. The method according to claim 6, wherein the communication channel comprises a synchronous communication protocol.

8. The method according to claim 7, wherein the synchronous communication protocol comprises WebSocket.

9. The method according to claim 6, wherein opening the communication channel comprises the client computer opening the communication channel.

10. The method according to claim 6, wherein opening the communication channel comprises the client computer conveying, over the network, an additional request to open the communication channel, and the security server opening the communication channel in response to receiving the additional request.

11. The method according to claim 6, wherein the processor comprises a client processor executing an endpoint agent, wherein the server comprises a server processor executing a file information library, wherein conveying the second request comprises the server processor conveying the second request to the file information library, and the file information library forwarding the second request to the endpoint agent over the communication channel, wherein conveying the retrieved metadata comprises the endpoint agent conveying the retrieved metadata to the file information library over the communication channel, and wherein conveying the decision comprises the server processor conveying the decision to the endpoint agent over the communication channel.

12. The method according to claim 11, wherein the endpoint agent comprises an extension for a web browser.

13. The method according to claim 1, wherein the first request comprises a request to upload the given file to a remote server.

14. The method according to claim 1, wherein the first request comprises a request to download the given file from a remote server.

15. The method according to claim 1, wherein the first request comprises a request to delete the given file.

16. The method according to claim 1, wherein the first request comprises a request to read data from the given file.

17. The method according to claim 1, wherein the first request comprises a request to write data to the given file.

18. A security server, comprising:
a network interface controller coupled to a network; and
a processor configured:
to receive, via the network, a notification indicating a client computer generating a first request to access a file,
in response to receiving the notification, to convey, to the client computer over the network, a second request to retrieve metadata from the given file,
to receive the requested metadata from the client computer in response to the second request, and
in response to receiving the conveyed metadata, to convey, to the client computer over the network, a decision as to whether to authorize the first request, so as to enable the client computer to respond to the first request in accordance with the decision.

19. A computer software product for protecting a client computer configured to access a set of files, the computer software product comprising a non-transitory computer-readable medium, in which program instructions are stored, which instructions, when read by the client computer and a security server, cause:
the client computer to detect a first request to access a given file in the set;
in response to the first request, the client computer to convey, prior to executing the first request, a notification of the first request over a network to the security server;
in response to receiving the notification, the security server to convey to the client computer over the network, a second request to retrieve metadata from the given file;
the client computer to retrieve, in response to receiving the second request, the requested metadata from the given file;
the client computer to convey, the retrieved metadata to the security server over the network;
in response to receiving the conveyed metadata, the security server to convey, to the client computer over the network, a decision as to whether to authorize the first request; and
the client computer to respond by to the first request in accordance with the decision.
